(19) United States
(12) Patent Application Publication
(10) Pub. No.: US 2019/0034873 A1
(43) Pub. Date: Jan. 31, 2019

(54) METHOD FOR PROVIDING REAL TIME PACKAGE TRACKING AND PACKAGE DELIVERY SECURITY

(71) Applicants: Miguel Boitel, Bronx, NY (US); Fancisco Collado, Mount Vernon, NY (US)

(72) Inventors: Miguel Boitel, Bronx, NY (US); Fancisco Collado, Mount Vernon, NY (US)

(21) Appl. No.: 16/040,120

(22) Filed: Jul. 19, 2018

Related U.S. Application Data
(60) Provisional application No. 62/536,543, filed on Jul. 25, 2017.

(51) Int. Cl. G06Q 10/08; G06K 9/00; G06F 17/30; G08B 13/00; G08B 31/00

(52) U.S. Cl. CPC G06Q 10/0833; G06K 9/00825; G08B 31/00; G08B 13/00; G06F 17/30241

(57) ABSTRACT

An apparatus, system, and method for real-time package tracking and delivery security are provided. In particular, the disclosure relates to apparatus, systems, and methods for tracking the real-time location of packages and generating real-time updates and geolocation displays accessible to users. According to an exemplary embodiment, apparatus, systems, and methods for real-time tracking of a package include: affixing a unique label to a package to be shipped; associating said package with a global positioning device present in a delivery vehicle; storing the global geolocation data of the vehicle and the package contents of the vehicle on an information storage device; updating the said stored information each time the vehicle is loaded and unloaded from a delivery vehicle; making available the stored information to an application; and providing the user of the application with the geolocation of the vehicle and package contained.

### TECHNICAL FIELD

The present invention relates generally to package tracking systems. More specifically, this invention relates to location tracking using global positioning system devices. Still more specifically, the present invention relates to the use of software applications to provide a GPS location of a package.

### CROSS REFERENCE TO RELATED APPLICATIONS

(Not applicable)

### STATEMENT REGARDING FEDERALLY SPONSORED RESEARCH OR DEVELOPMENT

(Not applicable)

### BACKGROUND OF THE INVENTION

Package/parcel tracking is widely used in the shipping and delivery industries to provide relative location and delivery estimates to customers awaiting deliveries. However, there exists a need for real time package tracking using global positioning system (“GPS”) devices to allow customers to follow the exact location of individual packages.

Real-time location tracking of packages solves several prevailing issues for consumers. The ability to track the delivery in real-time allows the customer to be present at the location of the delivery as it approaches its destination. Moreover, it allows customers to see the real-time location of the delivery, allowing customers to arrange a new pick up location for the package. This will save the carrier/delivery companies both time and money. Additionally, such a system reduces the incidences of false claims of stolen packages by detailing, in real-time, the exact time and location that the package was delivered. In the event a customer was not present for delivery, this system may provide the customer with the ability to retrace the package at a later time, lowering the incidences of false claims of non-delivery. This may also allow the customer, at cost, to receive their package by meeting the delivery vehicle while they are in route to another delivery location.

The application may also have the option to operate differently when delivering packages of high value. Where current delivery systems fail is in the safe and secured delivery of high value packages. The disclosed process may provide customers with a secure delivery system through the use of an application. The application may have the option of creating alias dots from the starting point of the package to delivery. The map may have the ability to display alias routes, routes that are not being taken by the delivery vehicle; nevertheless, the map may display this false tracking data to deceive any third party that wishes to interfere with the package delivery. The vehicles may be equipped with cameras or other recording devices to monitor the vehicles surrounding each vehicle. The system may capture and save images of each license plate of the vehicles, allowing the system to monitor the length of time and frequency in which particular vehicles follow the delivery vehicle. The system can further store tracking information in the network which will allow the couriers' system to immediately identify the vehicle as a habitual or reoccurring follower by storing dates and routes. This is used to evaluate potential threats to the delivery vehicle. The system may then relay this information utilizing a cloud-based storage system to a third party, in order to contact the authorities or the vehicle's driver, alerting them of a potential interference with the delivery vehicle. These features function to solve the existing issue of non-secured package delivery.

Current GPS tracking systems focus on tracking entire shipments and the majority of GPS systems fail to track individual packages using identification tags. Moreover, those package tracking systems that focus on tracking individual packages, do not provide exact locations of the individual packages in real time, and there is currently a lack of a convenient method for supplying this information to the customers. A need exists for a GPS tracking system that provides a customer with real-time individual package tracking and supplies this information conveniently over an application.

### SUMMARY OF THE INVENTION

While the above approach, which has been developed for years, works well for large shipments and supply chain applications or, in the case of individual packages for notification of arrival and/or departure from courier service facilities, in accordance with the present disclosure, it has been recognized that under certain circumstances the absence of real-time delivery schedule notifications prevent individuals from attending to delivery of individual packages and receiving and/or securing individual packages. For example, individuals may not be home and/or available for the entirety of delivery window, in particular wherein the delivery window is an entire day. However, real-time tracking of individual packages enables users to see the location of a package in real-time and to set and receive specific notifications, for example, to receive a notification when a package is fifteen minutes away from delivery, enabling the user to be available to receive the package while reducing the amount of time spent receiving the delivery. Perhaps even more critical is the issue of delivery security in which the customer is provided with a more exact delivery time and may also be provided with the option of either being present at the intended delivery location or picking up the package from the driver along his/her route.

The present disclosure provides for systems and methods for tracking individual packages and, in particular, for providing real time locations to customers through the use of an application for a smart phone, computer, tablet, webpage, etc.

According to an exemplary embodiment of the present disclosure, a method for real-time location tracking of a package is provided. The method comprises affixing an identifying label to a package, scanning said label upon loading or unloading onto a delivery vehicle, associating said identifying label with a GPS device permanently affixed and registered to said delivery vehicle, communicating said GPS device with a hard drive, and storing information on loaded and unloaded identification tags on said hard drive. Where the cloud-based system is not utilized, GPS devices and associated hard drives are installed in each delivery vehicle available, via network-connected devices, comprising a GPS network. More particularly, the method may further include a network device for sending and/or receiving information from the hard drive and/or storage device to an application. The application may be accessible to customers/users via a smartphone, computer, tablet, webpage, etc., or any programmable and/or network connected device. The application may display a graphical user interface which supplies information on the real-time location of a particular package to a customer awaiting receipt of said package. The method further comprise communicating with said application each and every time a particular package is loaded or unloaded from a vehicle within the GPS network.

According to another exemplary embodiment of the present disclosure, a system and method for delivering packages of high monetary value are provided. In particular, high value packages may be recognized by their unique identification tags, which may result in the following change in the system and method for delivery of the package. The system may associate a package with an alias for the receiving party. The system may further stamp the package with an incorrect address for purposes of deceiving third parties. The system may utilize multiple deliveries dots (alias dots), leaving from location of departure until the package arrives at the delivery destination. All alias dots may take different routes throughout the electronic geographic maps and spread accordingly to varying routes, therefore, misleading customers and any other third party of the exact location of a delivery vehicle. The actual delivery vehicle may not appear in maps displayed on the user interface, but a real time route may be synchronized with all alias dots such that the distance from an actual delivery point and/or an arrival time may be accurate. When alias dots are approaching an actual delivery destination, the delivery vehicle may go directly to the actual delivery destination while the alias dots may stop at varying addresses around the neighborhood, thereby misleading any third party that may be following and/or want to interfere with the high value delivery.

According to another exemplary embodiment of the present disclosure, systems and methods for additional delivery security are provided. In particular, systems and methods for additional security may equip delivery vehicles with a security camera in communication with an information storage device, which may be provided in coordination with the above disclosed embodiments. The system may save images of all license plates in said database, matching and recognizing the pictures of all cars with its make, model and color that has been repeatedly traveling along the delivery vehicle routes. The system may then match the length of time that the delivery vehicle has been followed by a particular vehicle from the first time the system identified the vehicle with the camera. The system may then record the vehicles current geographic location. When a positive recognition is made, the security system may send an alert to the carrier's main office and to the vehicle's driver giving a specific description of the described vehicle. Local police department may be notified as well, to take further steps for police intervention including, but not limited to, rerouting the vehicle, sending a police vehicle to the delivery vehicle, and sending the recorded vehicle's license plate information to the police station.

According to another exemplary embodiment of the present disclosure, a method for real-time location tracking of a package is provided. The method comprises affixing an identifying label to a package, scanning said label upon loading or unloading onto a delivery vehicle, associating said identifying label with a GPS device permanently affixed and registered to said delivery vehicle, and communicating said GPS device with a cloud-based information storage system. The cloud system communicates with the processors from each delivery vehicle possessing a GPS device, comprising a GPS network, and instantly sends and receives information when packages are loaded and unloaded from said vehicles. The cloud system may store said information on remote servers accessible from the internet. The method may further include an application for a smart phone, computer, tablet, etc. which supplies information on the location of a particular package to a customer awaiting receipt of said package in real-time.

According to another exemplary embodiment of the present disclosure, a method for real-time location tracking of a package is provided. The method comprises affixing an identifying label to a package, scanning said label upon loading or unloading onto a delivery vehicle, associating said identifying label with a GPS device permanently affixed and registered to said delivery vehicle, communicating said GPS device with a database available to the delivery organization. The method may further include a means for communicating the database with an application for a smart phone, computer, tablet, etc. which supplies information on the location of a particular package to a customer awaiting receipt of said package in real-time. The method may further include a GPS in each delivery vehicle available, comprising a GPS network. More particularly, the method may further comprise communicating with said application, optionally but desirably each and every time a particular package is loaded or unloaded from a vehicle within the GPS network. These and other features and attributes of the present disclosure and their advantageous applications and/or uses will be apparent from the detailed description which follows, particularly when read in conjunction with the figures appended hereto.

### BRIEF DESCRIPTION OF THE DRAWINGS

The operation of the inventive apparatus and method for real-time package tracking and package delivery security will become apparent from the following description taken in conjunction with the drawings, in which:

FIG. 1 is a flow chart of a method and system for real time package tracking in accordance with an exemplary embodiment of the present disclosure; and

FIG. 2 is a block diagram generally illustrating a system and method of providing the application user with the request package tracking information in accordance with an exemplary embodiment of the present disclosure.

### DETAILED DESCRIPTION OF THE PREFERRED EMBODIMENTS

The present disclosure provides a novel method for real time positional package tracking. The method is distinguishable over the prior art in that it provides real time individual package tracking by use of unique identification tags affixed to each package to be tracked. The advantageous characteristics of the disclosed system of package tracking include providing a real time map location of the package to its destination, allowing the user to better anticipate the delivery of their parcel.

Each participating delivery/carrier service may have all delivery vehicles (trucks, trains, planes, etc.) equipped with a GPS tracking device unique to each vehicle, creating a network of GPS tracking devices. In one exemplary embodiment of the present disclosure, the GPS device may be attached to a hard drive that is updated when packages are loaded and unloaded from the delivery vehicle. A participating package may have an affixed identification tag in one of the following non-limiting forms: a barcode, serial number, FRID tag or label. The identification tag is scanned when loaded and unloaded from a delivery vehicle. The hard drive and GPS device may store the information of each identification tag currently present in the vehicle. The hard drive is in communication with a real time package tracker application for a smart phone, tablet, computer etc. that utilizes the technology of electronic geographical maps, for example, those used by Google maps and Uber, to provide the application user with real time locations of the package.

In an alternative exemplary embodiment of the present disclosure, the delivery vehicles are not equipped with hard drives to store the identification tag information; rather, the GPS devices communicate with a cloud-based information storage system that stores the identification tag information on remote servers accessible from the internet. The real time package tracking application may utilize the information stored on the cloud and may update each time a package is scanned as it is loaded and unloaded from a particular delivery vehicle. The GPS locations may be available to the application user through Google maps or Uber technology.

In yet another alternative exemplary embodiment of the present disclosure, neither hard drives nor a cloud-based system is utilized to compile the information; rather, the existing data compilation by the carrier/delivery companies is utilized. Such companies already have information storage technology at their facilities. The existing technology would receive and store information on the GPS tracking devices of their vehicles and associated packages with identification tags within those vehicles. The information within the database would then be utilized by the real time package tracking application to provide the user with real-time locations of their packages using electronic geographical maps, for example, those used by Google maps and Uber.

In yet another alternative exemplary embodiment of the present disclosure, each vehicle may be equipped with a security camera in communication with said information storage database. The system may compile images of all license plates in said information storage database, matching and recognizing the pictures of all cars with its make, model and color that has been repeatedly traveling along the vehicle routes. The system may then match the length of time that the vehicle has been followed by a particular vehicle from the first time the system identified the vehicle with the camera. The system may then record the vehicles current geographic location. When positive recognition is made, the security system may send an alert to the carrier's main office and to the vehicle's driver giving a specific description of the described vehicle. Local police department may be notified as well, to take further steps for police intervention including, but not limited to, rerouting the vehicle, sending a police vehicle to the delivery vehicle, and sending the recorded vehicle's license plate information to the police station.

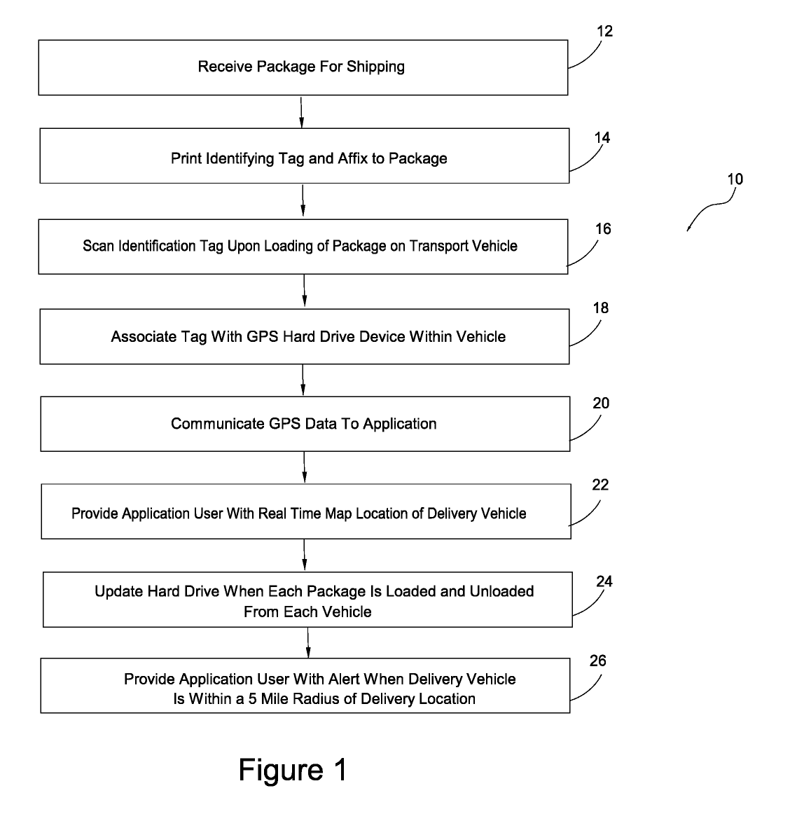

FIG. 1 is an exemplary non-limiting diagram detailing the steps of the disclosed system for real time package tracking. Referring to FIG. 1, the process begins with the receipt of a package 12 for shipping by a carrier/delivery service. If the customer has requested this service, a unique identification tag may be printed and affixed to the package 14 upon receipt. The tag functions in such a way as to be a machine-readable icon, code, or image that may allow for the immediate recognition and identification of the package. This code, which may be a bar code, is scanned 16 upon loading and unloading of the packages from a delivery vehicle. A delivery vehicle may be a vehicle, car, plane, train, or any other delivery vehicle capable of GPS tracking. Upon scanning, the identification tag may become associated with a GPS device present in the delivery vehicle 18. A hard drive in communication with the GPS device or a cloud-based information storage system may be utilized to store the information pertaining to which packages are present on each vehicle.

The data that is stored on the hard drive or cloud, and is made available 20 by means of a network- and/or internet-connected system to an application for a smart phone, computer, tablet, webpage, etc. The application may provide the user with a real time map image of the changing location of the delivery vehicle in which their package is contained 22. Each time the user's package is loaded or unloaded from a vehicle, the hard drive or cloud may update this information 24 and relay the data to the application. This may allow the user to track their package at each change in delivery vehicle. Alternatively, it may allow the user to know the time and location that their package is available to be picked up from a carrier/delivery facility. The application may send the user an alert 26 when the delivery vehicle is within a five-mile radius of the delivery location. This may allow the user to utilize their time efficiently and be present at the location for small window of time required.

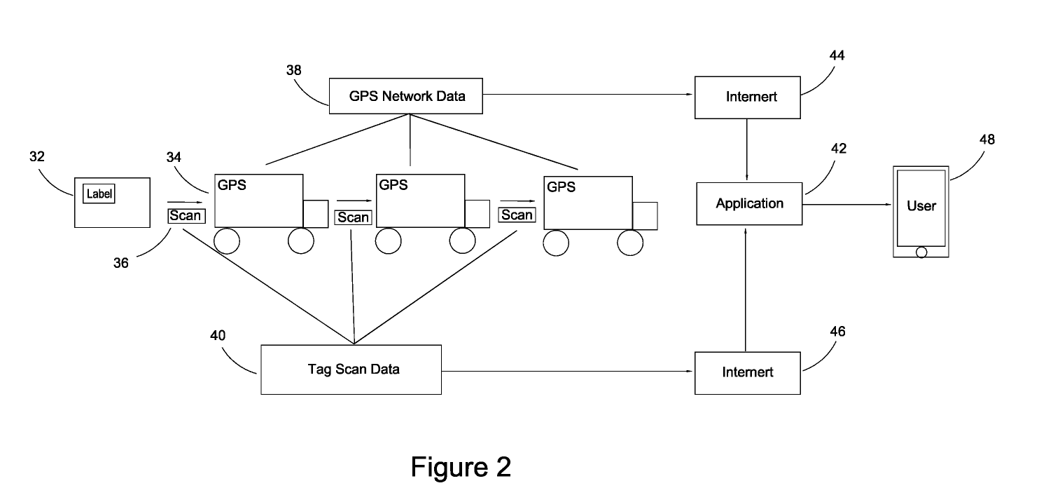

FIG. 2 is an exemplary non-limiting diagram detailing the disclosed system and method of providing the application user with the request package tracking information. Referring to FIG. 2, it depicts the process from shipping to receipt of the package 32. A package 32 is equipped with an identification tag upon request of the disclosed service. Often, carriers/delivery services may utilize multiple delivery vehicles 34 when delivering a package to a customer. Each participating vehicle 34 may be equipped with a GPS device to form a GPS network 38. Each time the package 32 is loaded or unloaded from a delivery vehicle 34, it is scanned 36 to associate the GPS of the vehicle with the identification tag of the package 32. The user 48 may access this information through the use of an application 42 that compiles the data from the GPS network 38 and the identification tag scan data 40 to provide the user with real time GPS tracking of their package 32. The GPS network data 38 is supplied to the application via internet or cellular communication 44. The tag scan data is supplied to the application via internet or cellular communication 46.

The package tracking system of the present disclosure described herein may be utilized in the following non-limiting types of applications and uses: providing a user with real time package tracking, providing a user with alerts when the package is at a particular distance from the delivery address, providing package security by means of alias routes on the application, providing package security by means of a camera system on the delivery vehicles, providing package security by means of providing an alias for the delivery recipient. The advantages of the disclosed tracking system include the following: tracking the delivery in real-time will allow the application user to be present at the location of the delivery as it approaches its destination; alerting the user when the package is within a five-mile radius of the delivery location; providing the real-time location of the delivery vehicle and allow for the pick up the package from the vehicle in a location other than the intended delivery location; alerting a customer when a package delivery has failed due to lack of an individual at the delivery location and instruct the user on when, where and how to obtain their package; and reducing the incidences of false claims of stolen packages by detailing exactly when and where the package was delivered.

While illustrative embodiments of the invention have been described, it is noted that various modifications will be apparent to those of ordinary skill in the art in view of the above description and drawings. Such modifications are within the scope of the invention which is limited and defined only by the following claims.

What is claimed is:

1. A method for real-time tracking of a package, the method comprising:
(a) affixing a unique label to a package to be shipped;
(b) associating said package to be shipped with a global positioning system in a delivery vehicle;
(c) recording the global position of the delivery vehicle containing said package to be shipped in real-time using the global positioning system.
(c) storing information on the associated package and global positioning system using an information storage system;
(d) updating said stored information when said package is removed from said delivery vehicle;
(e) continuing to update the stored information upon association of said package with additional delivery vehicles until the package reaches the delivery destination; and
(f) communicating said stored information and global positioning to an application.

2. The method of claim 1, wherein said unique label contains a unique computer-readable code to identify said package to be shipped.

3. The method of claim 1, wherein said application is capable of providing the real-time location of the package to be tracked.

4. The method of claim 1, wherein said application is capable of providing the user with alerts and notifications.

5. The method of claim 1, wherein said information storage device is a computer readable hard drive.

6. The method of claim 1, wherein said information storage system is a cloud-based information storage system.

7. The method of claim 1, wherein the application may display alias dots showing false real-time locations of the package.

8. The method of claim 1, wherein the unique label may contain an alias address and alias receiver name.

9. An apparatus for real-time tracking of a package, the apparatus comprising:
(a) a package
(b) a unique computer-readable shipping label;
(c) a global positioning device;
(d) an information storage system; and
(e) an application.

10. A method for secure delivery of a package, the method comprising:
(a) photographing license plates of vehicles near a delivery vehicle using security cameras affixed to the vehicle;
(b) storing the license plate numbers in an information storage system;
(c) making said license plate numbers available to the system for further vehicle identification;
(d) monitoring the length of time in which particular vehicles remain in a close proximity to a particular delivery vehicle; and
(e) sending an alert to the driver and third parties when a vehicle remains in close proximity for a prolonged period of time.
